(19) United States
(12) Patent Application Publication
(10) Pub. No.: US 2011/0177735 A1
(43) Pub. Date: Jul. 21, 2011

(54) ELASTOMERIC LAMINATE AND ELASTOMERIC FILM

(76) Inventors: Yuen-Lun TASI, Taipei City (TW); Hui-Ming Yen, Taipei City (TW); Wei-Yu Chen, Taipei City (TW)

(21) Appl. No.: 12/760,344

(22) Filed: Apr. 14, 2010

(30) Foreign Application Priority Data
Jan. 20, 2010 (TW) 099101533

(51) Int. Cl. B32B 5/02

(52) U.S. Cl. 442/62; 442/59

(57) ABSTRACT

An elastomeric laminate and an elastomeric film are provided. The elastomeric film can be a monolayer elastomeric film or a multilayer elastomeric film, wherein the monolayer elastomeric film includes an olefin-based elastomeric polymer and an effective polymer, and the multilayer elastomeric film when used as an alternative includes a first elastomeric member layer, and a second elastomeric member layer. The first elastomeric member layer includes at least one olefin-based elastomeric polymer, and at least one first draw down polymer. The second elastomeric member layer includes at least one elastomeric polymer and at least one second draw down polymer. The monolayer elastomeric film or the multilayer elastomeric film, and the elastic carrier are laminated together to form the elastomeric laminate.

### BACKGROUND OF THE INVENTION

1. Field of the Invention

The present invention relates generally to an elastomeric laminate include an elastomeric nonwoven fabric which is resilient, and an elastomeric film which can be used in the electronics industry, the constructions, the garments and the personal hygienic products.

2. The Prior Arts

Elastomeric fabrics have been widely used in many applications, such as sportswear, for comfortable and close-fitting wearing. Specifically, some elastomeric fabrics with good resilience and thermal insulation can be applied to the cuffs of cold-protective garment for reducing the heat loss from the cuffs, and thereby the body can be kept warm. Some garment, such as diapers, requires both good resilience and good thermal insulating properties. In accordance with a conventional method, a hot melt adhesive is attached to a non-elastic fabric, such as a nonwoven fabric, to form a composite fabric. The composite fabric is then treated with a physical treatment or a chemical treatment, so that the composite fabric can have the elasticity, and sometimes only have extensibility without resilience.

The elastomeric material used for fabricating the conventional elastomeric fabric is usually very expansive. Therefore, the elastomeric material is often made into the elastomeric films in order to reduce the production cost. However, the typical process for fabricating the elastomeric films is very complicated, and the undesirable tearing and pinholing often occur during fabrication of the elastomeric films by the conventional method.

### SUMMARY OF THE INVENTION

Accordingly, a primary objective of the present invention is to provide a solution to overcome the above-mentioned conventional drawbacks.

The present invention provides a cheep elastomer made of the special elastic nonwoven (U.S. Pat. No. 6,746,974B1) direct rubber membrane. In the present invention, the elastomeric film or the elastomeric laminate is used instead of the hot melt adhesive, and then the elastomeric film or the elastomeric laminate is attached to one layer or a multilayer of special elastomeric nonwoven fabric, and thus an elastomeric laminate fabric is obtained. The elastomeric fabric obtained by the present invention method has the elasticity without further conducting the physical or chemical treatment as required by the conventional method, use of general non-elastic fabric or low ductile nonwoven fabric. Moreover, the elastomeric fabric can not only achieve the extensibility, but also can achieve a real resilience, with an outstanding elastic characteristic, e.g., a low permanent set (percent). The elastomeric film and elastomeric laminate provide comfortable and close-fitting wearing for garment or personal hygiene products.

According to an embodiment of the present invention, the elastomeric film includes at least one olefin-based elastomeric polymer, and at least one draw down polymer. The elastomeric film has a basis weight not greater than 40 g, and has a permanent set (percent) not greater than 15% after recovery from being stretched to 100% of its original size.

According to an aspect of the embodiment, the olefin-based elastomeric polymer is selected from the group consisting of olefin block copolymer, olefin random copolyme, ethylene copolymer, propylene copolymer, ethylene olefin block copolymer, propylene olefin block copolymer, ethylene olefin random copolymer, propylene olefin random copolymer, ethylene-propylene random copolymer, ethylene-butene random copolymer, ethylene-hexene random copolymer, ethylene-heptene olefin block copolymer, propylene-ethylene olefin block copolymer, ethylene α-olefin copolymer, ethylene α-olefin random copolyme, ethylene α-olefin block copolymer, and mixtures thereof. A weight percent of the olefin-based elastomeric polymer relative to the mixture is about 60% to 95%. According to a further aspect of the embodiment, the olefin-based elastomeric polymer can also be replaced by the non-olefin-based elastomeric polymer.

The draw down polymer is selected from the group consisting of low-density polyethylene (LDPE), high-density polyethylene (HDPE), homopolymer polypropylene, and mixtures thereof. The weight percent of the draw down polymer relative to the mixture is about 1% to 20%.

According to an embodiment of the present invention, the elastomeric film includes a plurality of elastomeric layers (i.e. the multilayer elastomeric film). For example, the elastomeric film includes two elastomeric member layers. The first elastomeric member layer includes at least one olefin-based elastomeric polymer and at least one first draw down polymer, and the second elastomeric member layer includes at least one elastomeric polymer and at least one second draw down polymer. The multilayer elastomeric film has a basis weight not greater than 60 g, and has a permanent set (percent) not greater than 15% after recovery from being stretched to 100% of its original size. The basis weight of each elastomeric member layer is about 1 g to 10 g. The weight percentage of the first draw down polymer or the second draw down polymer relative to the mixture is about 1% to 25%. The weight percentage of the first elastomeric member layer relative to the multilayer elastomeric film is about 10% to 90%. The weight percentage of the second elastomeric member layer relative to the multilayer elastomeric film is about 10% to 90%. The olefin-based elastomeric polymer of the first elastomeric member layer is selected from the group consisting of ethylene-propylene random copolymer, ethylene-butene random copolymer, ethylene-hexene random copolymer, ethylene-heptene olefin block copolymer, propylene-ethylene olefin block copolymer, ethylene α-olefin copolymer, ethylene α-olefin random copolyme, ethylene α-olefin block copolymer, and mixtures thereof. The weight percentage of the elastomeric polymer relative to the mixture is about 70% to 95%. Further, the elastomeric polymer of the first elastomeric member layer can also be replaced with a non-elastomeric polymer.

The elastomeric polymer of the second elastomeric member layer is an olefin-based elastomeric polymer selected from the group consisting of block copolymer of vinyl arylene and conjugated diene, natural rubber, polyester rubber, rubber, polyether rubber, styrene block copolymer (SBC), styrene-butadiene-styrene block copolymer (SBS), styrene-isoprene-styrene block copolymer (SIS), styrene-isoprene-butadiene-styrene block copolymer (SIBS), styrene-ethylene-butylene-styrene block copolymer (SEBS), styrene-ethylene-propylene block copolymer (SEP), styrene-ethylene-propylene-styrene block copolymer (SEPS), styrene-ethylene-ethylene-propylene-styrene block copolymer (SEEPS), and mixtures thereof. The weight percentage of the elastomeric polymer of the second elastomeric member layer relative to the mixture is about 5% to 90%.

The first draw down polymer and the second draw down polymer are selected from the group consisting of low-density polyethylene (LDPE), high-density polyethylene (HDPE), homopolymer polypropylene, and mixtures thereof. The weight percentage of the first draw down polymer or second draw down polymer relative to the mixture is about 1% to 25%. The second draw down polymer can also be selected from the group consisting of polystyrene, high impact polystyrene (HIPS), linear low density polyethylene (LLDPE), high density polyethylene (HDPE), homopolymer polypropylene, and mixtures thereof. The weight percentage of the second draw down polymer relative to the mixture is about 3%.

According to an embodiment of the present invention, the multilayer elastomeric film further includes a third elastomeric member layer. The third elastomeric member layer includes at least one second elastomeric polymer and at least one third draw down polymer. According to this embodiment, the multilayer elastomeric film includes three elastomeric member layers, in which the first elastomeric member layer and the third elastomeric member layer are outer layers, and the second elastomeric member layer is an inner layer. The third elastomeric member layer includes at least one second olefin-based elastomeric polymer selected from the group consisting of styrene-butadiene-styrene block copolymer (SBS), styrene-isoprene-styrene block copolymer (SIS), styrene-isoprene-butadiene-styrene block copolymer (SIBS), butadiene-styrene block copolymer, styrene-ethylene-propylene block copolymer (SEP), styrene-ethylene-propylene-styrene block copolymer (SEPS), styrene-ethylene-ethylene-propylene-styrene block copolymer (SEEPS), and mixtures thereof. The third elastomeric member layer may further include at least one second non-elastomeric polymer. The third draw down polymer is selected from the group consisting of polystyrene, high impact polystyrene (HIPS), linear low density polyethylene (LLDPE), high density polyethylene (HDPE), homopolymer polypropylene, and mixtures thereof.

According to an aspect of the embodiment, the compositions of the first elastomeric member layer and the third elastomeric member layer have same components.

According to an aspect of the embodiment, the weight percentage of one of the outer layers relative to the multilayer elastomeric film is about 5% to 50%, and the weight percentage of the inner layer relative to the multilayer elastomeric film is about 10% to 90%. The weight percentage of the first elastomeric member layer is substantially equal to that of the third elastomeric member layer.

The preset invention also provides an elastomeric laminate. The elastomeric laminate includes a monolayer elastomeric film or a multilayer elastomeric film, and at least one carrier. The carrier serving as a substrate and the elastomeric film are laminated together to form the elastomeric laminate. The carrier has a basis weight about 3 g to 200 g. According to an embodiment of the present invention, the carrier is an elastic nonwoven fabric (U.S. Pat. No. 6,746,978B1) selected from the group consisting of elastic spunbond nonwoven fabric, elastic thermal bond nonwoven fabric, elastic meltblown nonwoven fabric, elastic spun lace nonwoven fabric, elastic spunbond-meltblown-spunbond nonwoven fabric, elastic spunbond-meltblown-meltblown-spunbond nonwoven fabric, elastic unbounded nonwoven fabric, and mixtures thereof.

According to an aspect of the embodiment, the monolayer elastomeric film or the multilayer elastomeric film, and the at least one elastic carrier are laminated together by adhesive bonding, thermal bonding, extrusion lamination, ultrasonic bonding, calendering, or combinations thereof.

According to an embodiment of the present invention, the elastomeric laminate further includes a first elastic nonwoven fabric and a second elastic nonwoven fabric. The monolayer elastomeric film or the multilayer elastomeric film has a first surface and a second surface. The first surface of the monolayer elastomeric film or the multilayer elastomeric film is bonded to the first elastic nonwoven fabric, and the second surface of the monolayer elastomeric film or the multilayer elastomeric film is bonded to the second elastic nonwoven fabric. According to an aspect of the embodiment, the first elastic nonwoven fabric is made of the same material as the second elastic nonwoven fabric.

According to an aspect of the embodiment of the present invention, the elastomeric film is fabricated by extruding a mixture of an olefin-based elastomeric polymer and at least one draw down polymer into a thin film.

In the present invention, the elastomeric film having a low basis weight is preferably fabricated. In accordance with an embodiment of the present invention, the elastomeric film is one monolayer of polyolefin-based thin film. The monolayer elastomeric film comprises a polyolefin-based layer that comprises one or more olefin-based elastomeric polymers blended with one or more draw down polymers. According to an embodiment of the present invention, the elastomeric film is a multilayer thin film including an olefin-based layer. The multilayer thin film may include two layers, three layers, four layers, five layers, or even more layers. The elastomeric film can also be bonded to one or more elastic fabrics, e.g., elastic nonwoven fabrics.

The draw down polymer is a polymer that adds or enhances one or more film properties or processing properties, so as to aid in processability during film preparation. The draw down polymer is a polymer that adds or enhances one or more film properties or processing properties, so as to aid in processability during film preparation. For example, the draw down polymer can aid in the production of reduced-gauge (i.e., thin) films. In some embodiments, the draw down polymer can aid in the film extrusion, such as by helping to provide an increased line speed or reduce draw resonance. Other possible processability benefits from the addition of the draw down polymer include improving the melt curtain stability, providing a smooth film surface, providing a lower viscosity of the polymer melt, providing better resistance to heat (e.g., increasing the film's thermal stability), providing resistance to tearing, providing resistance to pinhole formation, providing a controlled and uniform thickness, or providing a homogeneous composition. The draw down polymer can act as a processing aid that lubricates the die to reduce sticking of the elastomeric polymers and flow resistance of the molten elastomeric resin. Of course, the addition of the draw down polymer can provide one or a combination of these aids to film extrusion or processability.

The draw down polymer for example is a linear low-density polyethylene (LLDPE) (e.g., ELITE™ 5800 provided by Dow Chemical Corp.) can be added to a film composition to lower the viscosity of the polymer melt and enhance the processability of the extruded film. High-impact polystyrene (HIPS) (e.g., STYRON™ 485 from Dow Chemical Corp.) can help control the film modulus, improve the toughness of the film, and reduce the overall cost of the elastomeric material. Polypropylene can improve the robustness of the elastomer and improve the films' resistance to pinholing and tearing; Homopolymer polypropylene (HPP) (e.g., INSPIRE™ D118.01 from Dow Chemical Corp.; Polypropylene 3622 from Total Petrochemicals) can be added to improve processability. HPP is a form of polypropylene which is highly crystalline and containing essentially 100% propylene monomer. In some embodiments, HPP is added to a layer including an elastomeric polymer (e.g. styrene block copolymers). In some instances, a film can be extruded at a thinner gauge with improved gauge uniformity.

The draw down polymers can be linear low density polyethylene, propylene (LLDPE), propylene, homopolymer polypropylene, high impact polystyrene (HIPS), and mixtures thereof. The weight percentage of the draw down polymer relative to the mixture is about 1% to 20%. The draw down polymer can be a polymer which has been prepared using a single-site catalyst such as a metallocene catalyst (e.g., ELITE™ 5800 for producing polyolefin from Dow Chemical Corp.). The selection and the amount of draw down polymer can depend on the other components in the layer (e.g., the selection of the olefin-based elastomeric polymer in the layer). The total amount of draw down polymer can be present in an amount effective to enhance one or more film properties that aid in processability during film preparation. The total amount of the draw down polymers, e.g., the total amount of one or more draw down polymers, is about 5 wt % to 45 wt % which is relative to the thin film weight.

The olefin-based elastomeric polymer is selected from the group consisting of olefin block copolymer, olefin random copolymer, ethylene copolymer, propylene copolymer, or mixtures thereof. In some embodiments of the present invention, the olefin-based elastomeric polymer is selected from the group consisting of block copolymer of vinyl arylene and conjugated diene, natural rubber, polyurethane rubber, polyester rubber, polyamide rubber, polyether rubber, polyisoprene, or mixtures thereof. In some other embodiments, the olefin-based elastomeric polymer is selected from the group consisting of ethylene olefin block copolymer, propylene olefin block copolymer, ethylene olefin random copolymer, propylene olefin random copolymer, or mixtures thereof. In some other embodiments of the present invention, the olefin-based elastomeric polymer is selected from the group consisting of ethylene-propylene random copolymer, ethylene-butene random copolymer, ethylene-pentene olefin block copolymer, ethylene-hexene random copolymer, ethylene-heptene olefin block copolymer, ethylene-octene olefin block copolymer, ethylene-nonene olefin block copolymer, ethylene-decene olefin block copolymer, propylene-ethylene olefin block copolymer, ethylene α-olefin copolymer, ethylene α-olefin random copolymer, ethylene α-olefin block copolymer, or mixtures thereof. Examples of the olefin-based elastomeric polymers are olefin block copolymers (OBCs) which are elastomeric copolymers of polyethylene, sold under the trade name INFUSE™ by The Dow Chemical Company (e.g., INFUSE™ 9107). Other examples of olefin-based elastomeric polymers are copolymers of polypropylene and polyethylene, sold under the trade name VISTAMAXX™ by ExxonMobil Chemical Company (e.g., VISTAMAXX™ 1100). The total amount of the olefin-based elastomeric polymers relative to the layer weight is about 10 wt % to 90 wt %. Preferably, the total amount of the olefin-based elastomeric polymers relative to the layer weight is about 10 wt % to 70 wt %.

The olefin-based elastomeric polymer can be present in an amount to provide or enhance properties (including processing properties) of the olefin-based layer or of the elastomeric film. The olefin-based elastomeric polymer can provide better resistance to heat (e.g., the increase of the film's thermal stability) when compared to, for example, unsaturated styrene block copolymer elastomers. This better resistance to heat can aid in processing or extrusion; for example, a film including olefin-based elastomeric polymers can make it possible to extrude at higher temperatures without significant thermal degradation, at lower viscosity, and at a thinner gauge without tearing or pinholing. Olefin-based elastomeric polymers can have other enhanced processability characteristics, and therefore they can be easier to extrude as thin films. Moreover, the olefin-based elastomeric polymers tend to be chemically similar to the polyolefins used for the nonwoven fabric. This chemical similarity can improve the chemical affinity between the film layer and nonwoven fabric layers in the laminate. Therefore, the laminate can have improved bond strength.

The elastomeric film can optionally comprise other components that, in some instances, modify the film properties, aid in the processing of the film, or modify the appearance of the film. The viscosity-reducing polymers and plasticizers can be added as processing aids. High-density polyethylene (HDPE) can be added to help prevent aging or degradation of the other polymers. Other additives such as pigments, dyes, antioxidants, antistatic agents, slip agents, foaming agents, heat stabilizers, light stabilizers, inorganic fillers, organic fillers, or combinations thereof can be added. The amounts of these components relative to the layer weight can be about 0.1 wt % to 10 wt %.

Any film-forming process can be used to prepare the elastomeric film. For example, any blending process, such as melt blending, can be used. Also, any extrusion process, such as cast extrusion or blown-film extrusion can be used to form the film. If the elastomeric film is a multilayer film, the film can be formed by a coextrusion process.

The basis weight of the elastomeric film (e.g., a monolayer film) can be no more than about 40 g (about 0.1 g to 40 g) and can be, for example, about 1 g to 10 g.

The permanent set of the elastomeric film after recovery from being stretched to 100% of its original length can be no more than about 15%, and preferably about 0.5% to 15%.

In some embodiments, the elastomeric film layers comprise polymers that are inherently sticky or tacky. When such elastomeric films are extruded and wound into a roll, the film can sometimes stick to itself and sometimes become difficult or impossible to unwind. This problem can be solved in a number of ways. For example, the antiblocking agents, such as powdered inorganic materials (e.g., silica or talc) can be incorporated within layers of the film. The antiblocking agents can also be dusted onto the outer surfaces of extruded film as the film is being formed. The elastomeric film can also be surface-coated with materials that are not sticky, such as a brittle nonblocking polymer, or a surface coating such as a lacquer or ink, or other such coatings.

In a further embodiment of the present invention, the elastomeric film can be one or more layers of a multilayer film. In some multilayer embodiments, the elastomeric film includes two or more layers with (1) a first or polyolefin-based layer which comprises one or more olefin-based elastomeric polymers blended with one or more draw down polymers, as discussed above (e.g., including an optional additional elastomeric polymer that is not an olefin-based elastomeric polymer) and (2) a second layer that comprises one or more elastomeric polymers blended with one or more draw down polymers. The elastomeric polymers in the second layer can be olefin-based elastomeric polymers, non-olefin based elastomeric polymers, or combinations thereof. The one or more draw down polymers of the first layer can be the same or different as the one or more draw down polymers of the second layer. In two layer embodiments of the multilayer film, the polyolefin-based layer is sometimes referred to as a “surface” layer, and the second layer is sometimes referred to as a “central” layer. The two layer film can be a multilayer film.

In some embodiments of a three layer film, the film can be a coextruded multilayer film with an ABC sandwich type. In the ABC sandwich type construction, the A layer and the C layer can be the same or different composition. The A layer and the C layer form the outer layers of the film, which are sometimes referred to as the “surface” layers. The B layer, which is also referred to as the “central” layer, is the layer that comprises one or more elastomeric polymers, and the elastomeric polymer can be an olefin-based elastomeric polymers, or combinations thereof.

In some embodiments, the elastomeric multilayer film can include antiblocking agents or other components as needed to solve the blocking problems associate with layers having polymers that are inherently sticky.

As discussed above, any suitable blending method can be used to blend the components of the layers together. Furthermore, any extrusion process, such as cast extrusion or blown-film extrusion can be used to form the multilayer elastomeric film.

Additional processing steps can be performed on the elastomeric film, such as printing, slitting, laminating additional layers to the film, and other such processes.

The elastomeric films described herein can also be used to form a laminate. Such a laminate includes one or more substrate layers and the elastomeric film (e.g., monolayers or multilayers). The substrate layer may be an extensible and recoverable material including but not limited to another polymer film, fabric, nonwoven fabric, woven fabric, or knitted fabric. The elastomeric film can be bonded to substrate layers on one or both sides.

When two or more substrate layers are used to make the laminate, the substrate layers can be made of the same or different elastomeric material. The composition of the substrate layers can be the same or different, even when the same elastomeric material is used. The substrate layer (e.g., nonwoven fabrics) can have a basis weight of 3 g to 200 g. If two substrate layers are used, one layer can have a basis weight that is the same or different from the other. In some embodiments, the substrate layer is an elastic nonwoven fabric. For example, the substrate layer can be elastic spunbond nonwoven webs, elastic carded nonwoven webs (e.g., thermally bonded, adhesively bonded, or spunlaced), elastic meltblown nonwoven webs, elastic spunlaced nonwoven webs, elastic spunbond-meltblown-spunbond nonwoven webs, elastic spunbond-meltblown-meltblown-spunbond nonwoven webs, elastic unbonded nonwoven webs, elastic electrospun nonwoven webs, or combinations thereof. These fabrics can comprise fibers of polyolefins such as polypropylene or polyethylene, polyesters, polyamides, polyurethanes, elastomers, rayon, cellulose, copolymers thereof, or blends thereof or mixtures thereof. The nonwoven fabrics can also comprise fibers that have the homogenous structures or comprise the bicomponent structures.

### DETAILED DESCRIPTION OF THE PREFERRED EMBODIMENT

The embodiments described below are examples of the present invention and are not intended to otherwise limit the scope of the present invention in any way.

### Example 1

The elastomeric fabric of the present invention comprises a monolayer elastomeric film and two layers of special elastic nonwoven. The monolayer elastomeric films comprises 90% VISTAMAXX™ 1100 polyolefinic elastomer, from ExxonMobil Chemical, 5% ELITE™ 5800 linear low density polyethylene from Dow Chemical Company, and 5% white masterbatch concentrate (Schulman 8500) from Schulman Corporation. The elastomeric monolayer films were extruded on a cast-extrusion line. The basis weight of the elastomeric film is about 14 g to 20 g, and with basis weight fluctuation of less than 20%. These films were bonded with ultrasonic waves to two layers of 15 g Elaxus™ spunbond-meltblown-meltblown-spunbond (SMMS) polypropylene elastomeric nonwoven fabrics from Golden Phoenix Fiberwebs, Inc. The obtained elastomeric fabric showed good stretch and recovery characteristics, and the elastomeric fabric was resistant to pinholes and tearing.

### Example 2

The elastomeric laminate of the present invention comprises two layers of special elastic nonwoven and a multilayer ABA (sandwich) type elastomeric film, where the ABA layers were respectively about 25%, 50%, and 25% of the overall weight of the film composition. The A layers comprises 80% VISTAMAXX™ 1100 polyolefinic elastomer, 10% ELITE™ 5800 linear low density polyethylene, 5% INSPIRE™ D118.01 homopolymer polypropylene from Dow Chemical Company, and 5% ALATHON® m6060 high-density polyethylene from Equistar Chemicals. The B layer comprises 80% VECTOR™ 421 styrene-isoprene-styrene (SIS) block copolymer (from Dexco Polymer LP), 10% ELITE™ 5800 linear low density polyethylene, 5% INSPIRE™ D118.01 homopolymer polypropylene, and 5% white masterbatch concentrate (Schulman 8500) from Schulman Corporation. The multilayer elastomeric films were extruded on a cast-extrusion line. The films with target basis weights of less than 20 g and even as low as 10 g were extruded with no draw resonance, with no web breakage, and with basis weight fluctuation of less than 20%. This film was extrusion laminated to two layers of 8 g Elaxus™ spunbond-meltblown-meltblown-spunbond elastic polypropylene nonwoven fabrics from Golden Phoenix Fiberwebs, Inc. The elastomeric laminate showed good stretch and recovery characteristics, and was resistant to pinholes and tearing.

### Example 3

Two layers of Elaxus™ elastic polypropylene spunbond nonwoven fabrics (from Golden Phoenix Fiberwebs, Inc.) with a basis weight of 10 g each were applied to an elastomeric film on both its surfaces. The elastomeric film comprises 90% VISTAMAXX™ 1100 from ExxonMobil Company, 5% linear low density polyethylene (LLDPE) (ELITE 5800 from Dow Chemical Company), 3% white masterbatch concentrate (Schulman 8500), and 2% processing aid copolymer (LUVOFILM 9679 from Lehmann & Voss Co.) to make a white elastic film. The basis weight of the elastomeric film was about 20 g, and the total basis weight of the laminated composite was about 40 g (i.e., 10 g of nonwoven fabric+20 g elastomeric film+10 g of nonwoven fabric). As a comparison, the same elastomeric laminate was made except that the elastomeric film was made without adding LLDPE. This elastomeric film comprises 90% VISTAMAXX™ 1100, 3% white masterbatch concentrate, and 2% processing aid copolymer. This elastomeric film could be obtained with the basis weight of 46 g, and the total basis weight of the elastomeric laminate was about 66 g (i.e., 10 g of nonwoven fabric+46 g elastomeric film+10 g of nonwoven fabric).

### Example 4

The elastomeric laminate of the present invention comprises one layer of elastic nnonwoven fabric and an ABA (sandwich) type elastomeric film, where the ABA layers were respectively about 15%, 70%, and 15% of the overall weight of the film composition. The A layers comprises 90% INFUSE™ 9107 polyolefinic elastomer, 5% ELITE™ 5800 linear low density polyethylene, and 5% processing aid copolymer (LUVOFILM 9679 from Lehmann & Voss Co.). The B layer comprises 100% VISTAMAXX™ 1100. The composite elastomeric films had a basis weight of 25 g. This composite elastomeric film was extrusion laminated to one layer of 15 g Elaxus™ elastic polypropylene spunbond nonwoven fabric (PE/PP=70/30 of bicomponent, made from Golden Phoenix Fiberwebs, Inc.) to obtain the elastomeric laminate.

### Example 5

The elastomeric laminate of the present invention comprises one layer of elastic nonwoven fabric and an ABA (sandwich) type elastomeric film, where the ABA layers were respectively about 10%, 80%, and 10% of the overall weight of the film composition. The A layers comprises 65% INFUSE™ 9107 polyolefinic elastomer, 30% ELITE™ 5800 linear low density polyethylene, and 5% processing aid copolymer (LUVOFILM 9679 from Lehmann & Voss Co.). The B layer comprises 100% VISTAMAXX™ 1100. This elastomeric film was extrusion laminated to one layer of 20 g Elaxus™ elastic polypropylene spunbond nonwoven fabric (PE/PP=70/30 of bicomponent, made from Golden Phoenix Fiberwebs, Inc.) to obtain the elastomeric laminate.

As discussed above, the embodiments of the present invention include the elastomeric laminate at least one elastic nonwoven fabric and elastomeric films with a low basis weight and methods for making the elastomeric laminate. In some embodiments, the elastomeric film is a monolayer film of a polyolefin-based layer. The elastomeric film can also be a multilayer film having a non-polyolefin-based layer. The elastomeric film can also be part of a laminate formed with one or more substrates, elastic nonwoven fabrics. The choice of components (e.g., draw down polymers, olefin-based elastomeric polymers, and other elastomeric polymers) and the number of layers of the elastomeric film can benefit the film properties and the film processing properties.

1. An elastomeric laminate, comprising:
at least one elastic carrier and at least one elastomeric film; the elastic carrier, which is resilient, has the elongation of more than 120% after laminating the elastic carrier and the elastomeric film together without physical treatment or chemical treatment.

2. The elastomeric laminate as claimed in claim 1, wherein the elastic carrier is an elastic nonwoven fabric selected from the group consisting of elastic spunbond nonwoven fabric, elastic thermal bond nonwoven fabric, elastic meltblown nonwoven fabric, elastic spun lace nonwoven fabric, elastic spunbond-meltblown-spunbond nonwoven fabric, elastic spunbond-meltblown-meltblown-spunbond nonwoven fabric, elastic unbounded nonwoven fabric, and mixtures thereof.

3. The elastomeric laminate as claimed in claim 1, wherein the elastomeric film comprises at least one olefin-based elastomeric polymer; and at least one effective polymer wherein the elastomeric film has a basis weight of no more than 40 g, and the elastomeric film has a permanent set of no more than 15% after recovery from being stretched to 100% of its original size, and wherein the olefin-based elastomeric polymer is selected from the group consisting of olefin block copolymer, olefin random copolyme, ethylene copolymer, propylene copolymer, ethylene olefin block copolymer, propylene olefin block copolymer, ethylene olefin random copolymer, propylene olefin random copolymer, ethylene-propylene random copolymer, ethylene-butene random copolymer, ethylene-hexene random copolymer, ethylene-heptene olefin block copolymer, propylene-ethylene olefin block copolymer, ethylene α-olefin copolymer, ethylene α-olefin random copolyme, ethylene α-olefin block copolymer, and mixtures of thereof, wherein an amount of the olefin-based elastomeric polymer relative to the monolayer elastomeric film is 60 wt % to 95 wt %.

4. The elastomeric laminate as claimed in claim 1, wherein the olefin-based elastomeric polymer is substituted by a non-olefin-based elastomeric polymer.

5. The elastomeric laminate as claimed in claim 1, wherein the effective polymer comprises a draw down polymer selected from the group consisting of: low-density polyethylene (LDPE), high-density polyethylene (HDPE), homopolymer polypropylene, and mixtures thereof, and an amount of the draw down polymer relative to the monolayer elastomeric film is 1 wt % to 20 wt %.

6. A multilayer elastomeric film, comprising:
a first elastomeric member layer comprising (a) at least one olefin-based elastomeric polymer, and (b) at least one first draw down polymer; and
a second elastomeric member layer comprising (a) at least one elastomeric polymer and (b) at least one second draw down polymer,
wherein the multilayer elastomeric film has a basis weight of no more than 60 g, and the multilayer elastomeric film has a permanent set of no more than 15% after recovery from being stretched to 100% of its original size, and a basis weight of each of the first elastomeric member layer and the second elastomeric member layer is 1 g to 10 g.

7. The multilayer elastomeric film as claimed in claim 6, wherein the olefin-based elastomeric polymer of the first elastomeric member layer is selected from the group consisting of ethylene-propylene random copolymer, ethylene-butene random copolymer, ethylene-hexene random copolymer, ethylene-heptene olefin block copolymer, propylene-ethylene olefin block copolymer, ethylene α-olefin copolymer, ethylene α-olefin random copolyme, ethylene α-olefin block copolymer, and mixtures thereof, wherein an amount of the elastomeric polymer relative to the multilayer elastomeric film is 70 wt % to 95 wt %.

8. The multilayer elastomeric film as claimed in claim 6, wherein the first draw down polymer and the second draw down polymer are selected from the group consisting of low-density polyethylene (LDPE), high-density polyethylene (HDPE), homopolymer polypropylene, and mixtures thereof, wherein an amount of the first draw down polymer or second draw down polymer relative to the multilayer elastomeric film is 1 wt % to 25 wt %.

9. The multilayer elastomeric film as claimed in claim 6, wherein the elastomeric polymer of the second elastomeric member layer is a non-elastomeric polymer.

10. The multilayer elastomeric film as claimed in claim 6, wherein the elastomeric polymer of the second elastomeric member layer is an olefin-based elastomeric polymer selected from the group consisting of block copolymer of vinyl arylene and conjugated diene, natural rubber, polyester rubber, polyurethane rubber, polyether rubber, styrene block copolymer (SBC), styrene-butadiene-styrene block copolymer (SBS), styrene-isoprene-styrene block copolymer (SIS), styrene-isoprene-butadiene-styrene block copolymer (SIBS), styrene-ethylenebutylene-styrene block copolymer (SEBS), styrene-ethylene-propylene block copolymer (SEP), styrene-ethylene-propylene-styrene block copolymer (SEPS), styrene-ethylene-ethylene-propylene-styrene block copolymer (SEEPS), and mixtures thereof, wherein an amount of the elastomeric polymer of the second elastomeric member layer relative to the multilayer elastomeric film is 5 wt % to 90 wt %.

11. The multilayer elastomeric film as claimed in claim 6, wherein the second draw down polymer is selected from the group consisting of polystyrene, high impact polystyrene (HIPS), linear low density polyethylene (LLDPE), high density polyethylene (HDPE), homopolymer polypropylene, and mixtures thereof, and an amount of the second draw down polymer relative to the multilayer elastomeric film is 3 wt %.

12. The multilayer elastomeric film as claimed in claim 6, wherein an amount of the first elastomeric member layer relative to the multilayer elastomeric film is 10 wt % to 90 wt %, and an amount of the second elastomeric member layer relative to the multilayer elastomeric film is 10 wt % to 90 wt %.

13. The multilayer elastomeric film as claimed in claim 6, further comprising a third elastomeric member layer, wherein the third elastomeric member layer comprises a second elastomeric polymer, and at least a third draw down polymer, wherein the multilayer elastomeric film comprises three elastomeric member layers, and the first elastomeric member layer and the third elastomeric member layer are outer layers, and the second elastomeric member layer is an inner layer.

14. The multilayer elastomeric film as claimed in claim 13, wherein the third elastomeric member layer comprises at least one second olefin-based elastomeric polymer selected from the group consisting of styrene-butadiene-styrene block copolymer (SBS), styrene-isoprene-styrene block copolymer (SIS), styrene-isoprene-butadiene-styrene block copolymer (SIBS), butadiene-styrene block copolymer, styrene-ethylene-propylene block copolymer (SEP), styrene-ethylene-propylene-styrene block copolymer (SEPS), styrene-ethylene-ethylene-propylene-styrene block copolymer (SEEPS), and mixtures thereof.

15. The multilayer elastomeric film as claimed in claim 13, wherein the third elastomeric member layer comprises at least one second non-olefin-based elastomeric polymer.

16. The multilayer elastomeric film as claimed in claim 13, wherein the third draw down polymer is selected from the group consisting of polystyrene, high impact polystyrene (HIPS), linear low density polyethylene (LLDPE), high density polyethylene (HDPE), homopolymer polypropylene, and mixtures thereof.

17. The multilayer elastomeric film as claimed in claim 13, wherein the first elastomeric member layer and the third elastomeric member layer have the same composition.

18. The multilayer elastomeric film as claimed in claim 13, wherein an amount of each outer layer relative to the multilayer elastomeric film is 5 wt % to 50 wt %, and an amount of the inner layer relative to the multilayer elastomeric film is 10 wt % to 90 wt %.

19. The multilayer elastomeric film as claimed in claim 13, wherein the first elastomeric member layer has a wt % of the multilayer elastomeric film that is substantially equal to the third elastomeric member layer wt % of the multilayer elastomeric film.

20. An elastomeric laminate, comprising:
a monolayer elastomeric film as claimed in claim 1; and
at least one elastic carrier,
wherein the monolayer elastomeric film or the multilayer elastomeric film, and the at least one elastic carrier are laminated together to form the elastomeric laminate, and wherein a basis weight of the elastic carrier is 3 g to 200 g.

21. The elastomeric laminate as claimed in claim 20, wherein the monolayer elastomeric film or the multilayer elastomeric film, and the at least one elastic carrier are laminated together by adhesive bonding, thermal bonding, extrusion lamination, ultrasonic bonding, calendering, or combinations thereof.

22. The elastomeric laminate as claimed in claim 20, further comprising a first elastic nonwoven fabric, and a second elastic nonwoven fabric, wherein the monolayer elastomeric film or the multilayer elastomeric film has a first surface and a second surface, and the first surface of the monolayer elastomeric film or the multilayer elastomeric film is bonded to the first elastic nonwoven fabric, and the second surface of the monolayer elastomeric film or the multilayer elastomeric film is bonded to the second elastic nonwoven fabric.

23. The elastomeric laminate as claimed in claim 22, wherein the first elastic nonwoven fabric and the second elastic nonwoven fabric are made of the same fabric material.

24. An elastomeric laminate, comprising:
a multilayer elastomeric film as claimed in claim 9; and
at least one elastic carrier,
wherein the monolayer elastomeric film or the multilayer elastomeric film, and the at least one elastic carrier are laminated together to form the elastomeric laminate, and wherein a basis weight of the elastic carrier is 3 g to 200 g.

25. The elastomeric laminate as claimed in claim 24, wherein the monolayer elastomeric film or the multilayer elastomeric film, and the at least one elastic carrier are laminated together by adhesive bonding, thermal bonding, extrusion lamination, ultrasonic bonding, calendering, or combinations thereof.

26. The elastomeric laminate as claimed in claim 24, further comprising a first elastic nonwoven fabric, and a second elastic nonwoven fabric, wherein the monolayer elastomeric film or the multilayer elastomeric film has a first surface and a second surface, and the first surface of the monolayer elastomeric film or the multilayer elastomeric film is bonded to the first elastic nonwoven fabric, and the second surface of the monolayer elastomeric film or the multilayer elastomeric film is bonded to the second elastic nonwoven fabric.

27. The elastomeric laminate as claimed in claim 26, wherein the first elastic nonwoven fabric and the second elastic nonwoven fabric are made of the same fabric material.
